(19) United States
(12) Patent Application Publication
(10) Pub. No.: US 2009/0044195 A1
(43) Pub. Date: Feb. 12, 2009

(54) METHOD FOR PERFORMING TASKS BASED ON DIFFERENCES IN MACHINE STATE

(75) Inventor: Jack A. Nichols, Kirkland, WA (US)

Correspondence Address: DAVIS WRIGHT TREMAINE, LLP/Seattle, 1201 Third Avenue, Suite 2200, SEATTLE, WA, 98101-3045, US

(73) Assignee: Kivati Software, LLC, Bellevue, WA (US)

(21) Appl. No.: 12/115,487

(22) Filed: May 5, 2008

Related U.S. Application Data
(60) Provisional application No. 60/915,846, filed on May 3, 2007.
(60) Provisional application No. 60/915,843, filed on May 3, 2007.

(51) Int. Cl. G06F 9/44

(52) U.S. Cl. 718/106

(57) ABSTRACT

A task generation system and method produces tasks to be executed on a target non-volatile data system based on state differences between the target system and a source non-volatile data system as found in state files and a state difference list. The tasks are generated by state difference translators according to differences between state files of the source and target systems.

### CROSS REFERENCE TO RELATED APPLICATION(S)

This application claims priority benefit of provisional application Ser. No. 60/915,843 filed May 3, 2007, the content of which is incorporated in its entirety.

This application is related to copending application by Jack A. Nichols, entitled “A Method For Determining And Storing The State Of A Computer System”, filed on May 5, 2008, which application is hereby incorporated by reference in its entirety, including any appendices and references thereto.

This application is related to copending application by Jack A. Nichols, entitled “A Method For Differentiating States Of N Machines”, filed on May 5, 2008, which application is hereby incorporated by reference in its entirety, including any appendices and references thereto.

This application is related to copending application by Jack A. Nichols, entitled “A Method Of Determining Dependencies Between Items In A Graph In An Extensible System”, filed on May 5, 2008, which application is hereby incorporated by reference in its entirety, including any appendices and references thereto.

### BACKGROUND OF THE INVENTION

1. Field of the Invention

The present invention is directed generally to data systems.

2. Description of the Related Art

Modern computer systems are complex and contain large amounts of data that directly affects their operation. This data is stored in a variety of mediums, and affects the computer's operation in different ways. Some data represents applications that modify other data; some data represents configuration files that modify applications; some data represents data created or used by the user.

Data storage mediums are either volatile or non-volatile. The content of data in volatile mediums is erased whenever the computer system is powered off. The content of data in non-volatile mediums, by contrast, persists through power cycles. Volatile mediums in modern computer systems include the main system memory (RAM), the processor's cache memory, the processor's registers, and any other caching systems present in the computer, such as a hard disk cache. Non-volatile mediums in modern computer systems include hard disks, removable disks, and storage devices (such as floppy disks, CD and DVD discs, USB drives, etc).

While the data stored in volatile mediums is useful for the operation of a computer system, it is the data stored in non-volatile mediums that defines how the computer system operates. Consider two identical pieces of computer hardware A and B. If hardware A contains non-volatile data X, we can make hardware B behave exactly like hardware A by copying non-volatile data X to hardware B. We refer to X as the state of hardware A, and in general the non-volatile data stored in a computer system as the state of the computer system.

Although moving the entire non-volatile state from one computer to another is sometimes desired behavior, such as in the case of a backup and restore operation, most often only a subset of the non-volatile state should be moved. For example, to deploy an application from one computer to another, it is not necessary to overwrite the target computer's operating system, user documents, or other settings. Only the data directly related to the application should be moved. Efficiency is further increased if only the data that differs between non-volatile states is moved. If, for example, both states contain an identical copy of a file, there is no need to move that data between the states, as it already exists. If the file is different, however, it should be copied to the target state.

In order to move only the data that differs between non-volatile states, the differences between the states could possibly be detected by an system, or supplied by a user. Furthermore, knowledge of the data and how it is stored is used. For example, in the case of a file, moving the data may be as simple as copying the data contained within the file to a target state. However, a more complex structure, such as a database table, may live within another file or other data structure, and knowledge of that data structure is required to successfully copy the differences in the data.

Complex data structures, such as databases, configuration, and other such items, are typically contained within files on a non-volatile storage medium, such as a hard disk. The format of these files is typically not disclosed to anyone outside of the organization that authored the computer program that reads and writes them. In other words, it is difficult, if not impossible, for a third party to examine or modify the contents of the files without using the computer program originally designed to modify them.

Conventional approaches to moving or copying data from one non-volatile machine to another are helpful, improvements can still be made.

### BRIEF DESCRIPTION OF THE SEVERAL VIEWS OF THE DRAWING(S)

FIG. 1 is a schematic block diagram of a computer and associated equipment that is used with implementations of the system.

FIG. 2 is a schematic of sample source input data to a task generation system.

FIG. 3 is a schematic of sample target input data to the task generation system.

FIG. 4 is a schematic of sample data used to illustrate delete swapping.

FIG. 5 is a schematic of an end state of the delete swapping example of FIG. 4.

### DETAILED DESCRIPTION OF THE INVENTION

As discussed herein, a task generation system and method produces tasks to be executed on a target non-volatile data system based on state differences between the target system and a source non-volatile data system. The tasks are generated by state difference translators. State files of the source and target systems can be generated according to co-pending patent application entitled “A method of determining and storing the state of a computer system” wherein orchestrators, guides, and analyzers are used, or according to other approaches to generating state files. A difference list between the source and target state files can then be generated according to co-pending patent application entitled “A method for differentiating states of N machines” or by another approach.

In some implementations, the task generation system analyzes the difference list and produces a series of actions to be performed through execution of generated tasks. In these implementations, the result of executing this series of actions is that the states of the source and target systems are identical. The series of actions that is generated is based on the differences between states and with the assumption that the directionality of the differences is explicitly specified. Some of the actions could include but are not limited to creating, modifying, deleting, or accessing files, folders, database tables, database views, database table columns, database table rows, database metadata, database scripts, security descriptors, computer metadata, or objects or data used by the computer system and stored in one of the above stores. Other actions are discussed in co-pending patent applications incorporated by reference above.

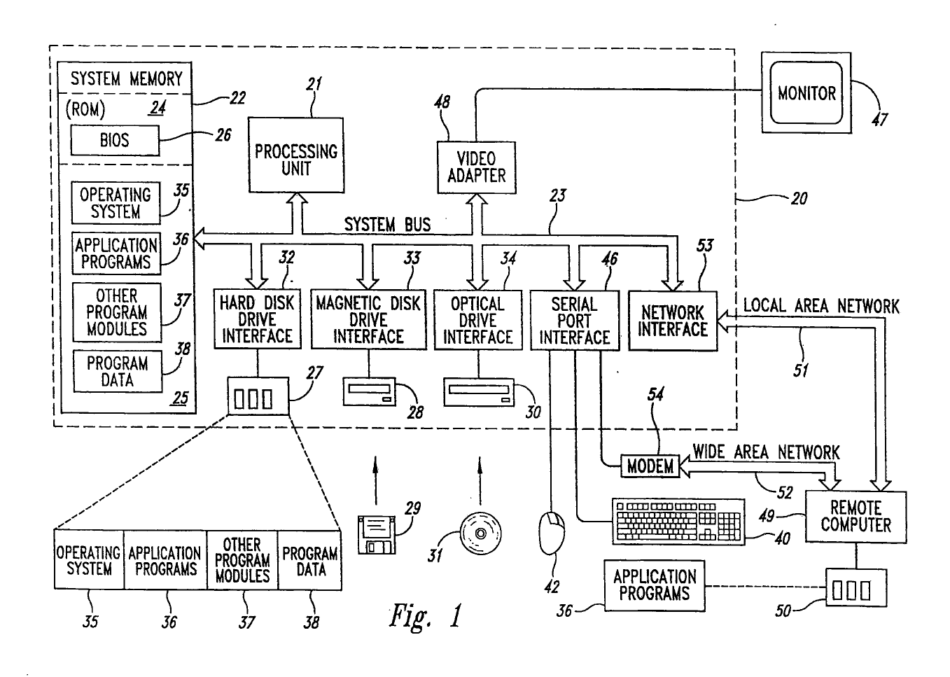

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

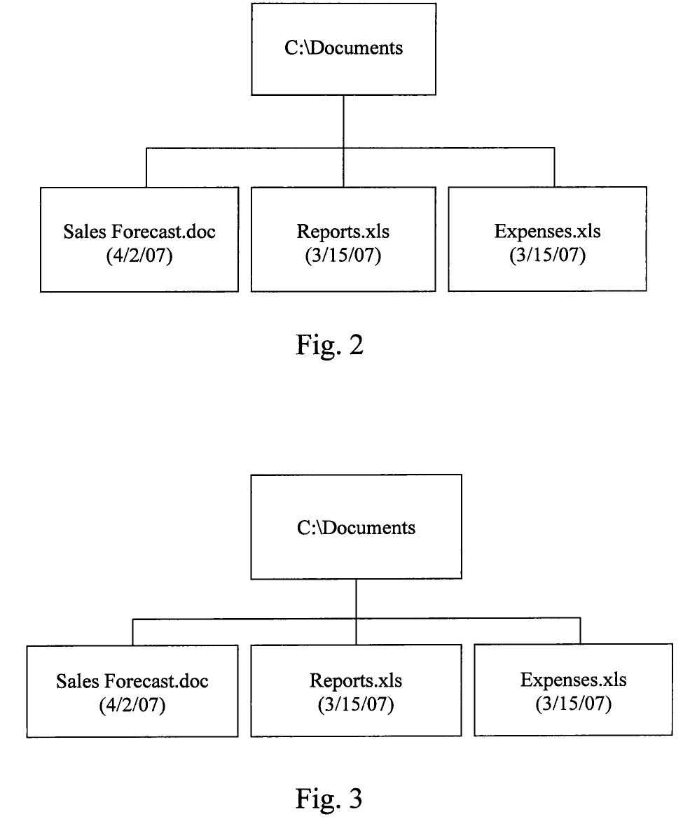

To illustrate some concepts involved, a machine with a file system having a machine state A is represented by a diagram shown in FIG. 2. Further, a machine with the file system having machine state B is depicted in FIG. 3. Differences between states of machine A and machine B can be represented by Table 1.

TABLE 1

| Item | Difference Type |
|---|---|
| Reports.xls | Not in B |
| Expenses.xls | Different |
| TPS Report.doc | Not in A |

Given state A, state B, and the differences shown in Table 1, we now need a way to construct a series of actions to make state B equal to state A. That is, after performing the actions, if the set of differences is reconstructed, it should be an empty set.

Many application vendors that store information in data files have provided application programming interfaces (APIs) to enable third parties to access their data files. These APIs usually have a pre-defined set of functionality and can be used by any third party with an inclination to do so.

Modifying complex data in non-volatile storage is usually easiest to accomplish when using published application programming interfaces, rather than modifying the data directly. Not only does this approach require significantly less effort on the part of the party doing the data modification, but in some cases, directly modifying an application's data files may void any warranty or support agreements with the application's vendor.

Modifications to data stored in non-volatile storage can be considered a series of actions. For example, to modify a database's non-volatile storage such that a table exists with two columns, a series of actions could be “Create table A”, “Add column B”, “Add column C”. Such actions are discrete units of work that, when taken together, perform the overall modification.

The series of actions to take is dependent on the directionality of the differences. That is, the actions that one should take to make state A identical to state B (in this case, state A is the target and state B is the source) are different actions than one should take to make state B identical to state A (in this case, state B is the target and state A is the source). Therefore, the differences that are provided as inputs to determine the series of actions should have a defined directionality. Many application programming interfaces provide facilities for performing modifications as a series of actions. In the preceding example, the series of actions would call published application programming interfaces to perform each action.

In order to construct the series of actions to perform for a given modification, knowledge of both the data being moved and the application programming interfaces required to move it is required. It is also of note that it is poor software design to imbue an system with this complete knowledge for all possible operations to perform. A reasonable and maintainable approach is to use a series of extensions to perform both the work of invoking the application programming interfaces and to determine the correct actions to invoke.

As discussed above, input to the task generation system includes state files representing source and target states and a list of differences between the state files including the nature of those differences. As stated above, in implementations, the state files provided as input could be generated as described in the co-pending patent application entitled, “A method of determining and storing the state of a computer system.” This input format provides several important properties:
All items in the state are identified by a predictable and unique key
All items in the state contain produced and consumed evidence that can be used to construct a dependency graph
The state format provides an index into the produced evidence store for use in generating the dependency graph as described in A method of determining dependencies between items in a graph in an extensible system

As stated above, in implementations, the list of state differences provided as input could be generated as described in the co-pending patent application, entitled, “A method for differentiating states of N machines.” This input format provides several important properties:
The difference state of all items in all state files is provided
The nature of each difference is provided

As mentioned above, each difference in state amounts to a series of actions to take in order to make the states equal. Because it is impractical for the system to have the necessary knowledge to perform these actions entirely self-contained, these functions are delegated to special extensions called tasks. Each task performs an action, such as copying a file, rebooting the computer, setting a registry value, or other functions.

Tasks can perform either a single action, or can perform several actions. Tasks can be provided by either first or third party, and can be added to the system to offer additional capabilities.

In addition to delegating action functionality to tasks, the system also delegates the logic to translate a difference into a series of tasks to special extensions called difference translators. A difference translator is responsible for translating a specific class of differences (such as file differences, registry differences, etc.) into a specific series of tasks that when executed results in a specific series of actions. To accomplish this, difference translators have knowledge of both the analyzers used to generate the state files if the approach of the referenced co-pending patent application entitled, “A method of determining and storing the state of a computer system,” is used and the tasks related to the specific type of data involved.

In implementations, tasks created by the difference translator based on state differences are instances of classes (in the object-oriented programming sense) that implement the needed task functionality. This permits reuse of code and simplification of the difference translator, as they can simply use pre-canned functionality by providing a set of inputs to each task.

Tasks can be generated to any storage location that is suitable for the specific implementation, such as disk or memory. The specific implementation is responsible for providing a mechanism for storing tasks and ensuring that the difference translators are using the storage location.

As mentioned, difference translators have knowledge of the data stored by the analyzer and used by the tasks for a specific type of data, such as “Files”, “Web Sites”, or “Registry Data”. To link the proper extensions with the proper data in the state files, implementations store the name of the analyzer extension that wrote the data for each item. Then, as the system is reading the state file, it can offer this information to each difference translator, and each difference translator can decide if it is able to read the type of data offered.

For example, consider file data in a machine state. Table 2 lists below the roles played by each of the extensions involved in generating tasks for this type of data.

TABLE 2

| Function | Description |
|---|---|
| Analyzer | Analyzes files and stores state information about them, |
| | including their data, in the state file. |
| Task | Performs a specific file system task, such as: |
| | Copying a file |
| | Deleting a file |
| | Moving a file |
| | Creating a new file |
| | Etc |
| Difference | Translates the differences for files in the list of differences |
| translator | into one or more tasks to execute. |

The specific implementation of a difference translator is left up to the author of the extension, but in general, difference translators should contain some type of translation table for translating differences into tasks. For example, the following table could be used as a difference translator translation table for files:

TABLE 3

| Difference | Tasks |
|---|---|
| Same | No tasks |
| Not in Source | Delete from target |
| Not in Target | Copy to target |
| Different | Copy to target |

The list of tasks can, of course, be much more complex. Depending on the design of the tasks library that the difference translator is using, it may need to generate several tasks for a given difference, or it may need to analyze the content of the data in the state file in the context of the difference to determine the proper tasks to create. For example, consider a difference translator for Microsoft Windows system registry values:

TABLE 4

| Difference | Tasks |
|---|---|
| Same | No tasks |
| Not in Source | Open containing key, delete value, close |
| | containing key |
| Not in Target | Open containing key, set value, close |
| | containing key |
| Different | Open containing key, set value, close |
| | containing key |

Difference translators often need data from the state files in order to correctly generate a task. For example, in order to copy a file, the difference translator needs the data for the file, which is held in the state files. For this reason, the difference translators should be provided with a reference to the state files used to generate the difference list. Using the difference type, the difference translator can infer the correct state file to load data from. For example, “Not in Target” for a file implies that the file is being copied from the source to the target, and so the difference translator should look in the source state file for the file's data.

In implementations, the process of identifying the state file that contains data for the operation is handled by the difference generation system. An extra field is added to the difference list that references the state file that is associated with the difference. This provides two benefits. One, it eliminates the need for the difference translator to infer the state file to use for data, since it is explicitly specified in the difference list. Second, it provides merge strategies (discussed in detail in A method for differentiating states of N machines) a way of specifying the state file that contains the merged data. This information would be difficult to infer by the difference translator without an explicit specification of which file to use by the merge strategy.

In implementations, tasks are responsible for declaring their own dependencies. In other words, each task contains a list of other tasks that it depends on. Task dependencies permit some tasks to perform their work before other tasks. For example, in order to create a file in a directory, the directory should first exist. Therefore, a task that creates a file in a directory has a dependency on the directory that the file should be contained in.

To facilitate dependencies, one embodiment of the system makes use of the dependency graph computation system as described in co-pending patent application entitled, “A method of determining dependencies between items in a graph in an extensible system.” This dependency graph is then provided to the difference translators, and each difference translator is responsible for examining the graph and using its contents to set the dependencies on each task it creates. This approach offers flexibility to the difference translator system to choose where the dependencies on each task are set. This could be important, for example, in cases where multiple tasks are created for each difference in the difference list.

In implementations, the dependency graph generated from the system described in co-pending patent application entitled, “A method of determining dependencies between items in a graph in an extensible system” is generated with the following changes from that which was originally described:
Both directions of the dependency are generated. In other words, each node in the graph has both a list of items it depends on and a list of items that depend on it.
Items that translate to a “delete” action (in other words, “Not in Source”) have their dependencies swapped (called delete swapping).

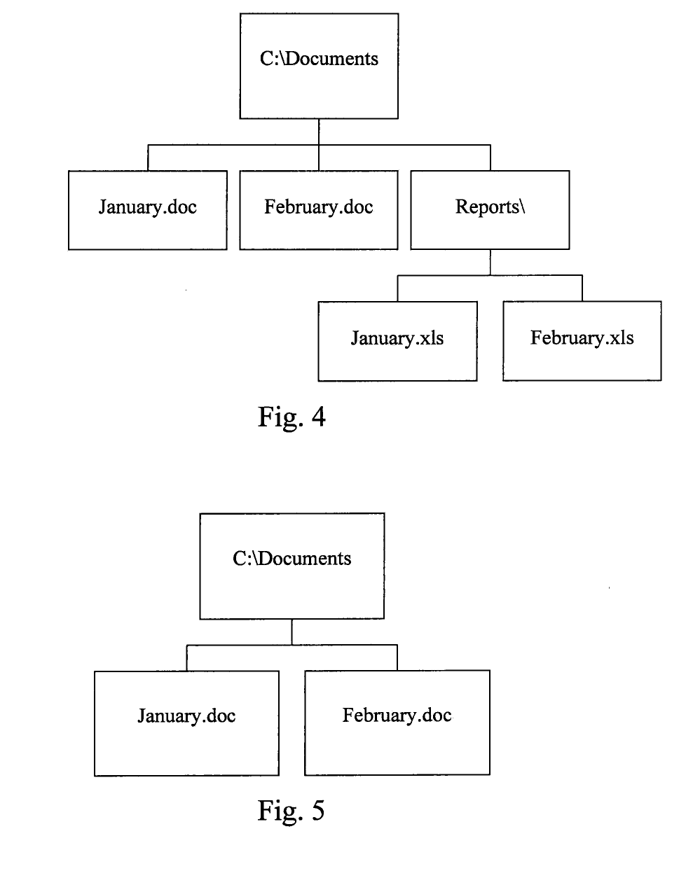

Delete swapping requires additional explanation to understand the reason for this change. Consider the following file system structure shown in FIG. 4.

This structure exists on both the source and target machines. Now, consider what happens if we delete the directory “Reports” on the source machine as shown in FIG. 5. Note that in the source state, deleting the directory “Reports” has also deleted the files contained within it, “January.xls” and “February.xls”. The difference list between this source and target example might look like the following in Table 5.

TABLE 5

| Item | Difference |
|---|---|
| “Reports\” | Not in Source |
| “January.xls” | Not in Source |
| “February.xls” | Not in Source |

Using the difference translator table described above, the file difference translator should translate “Not in Source” to “Delete file”. Similarly, we could expect a directory difference translator to translate “Not in Source” to “Delete directory” for a directory.

In the dependency model as presented in co-pending patent application entitled, “A method of determining dependencies between items in a graph in an extensible system,” “January.xls” and “February.xls” have a dependency on “Reports”. However, if tasks are generated based on this model and based on the tables above, the tasks could execute in the following order:
1. Delete directory “Reports”
2. Delete file “January.xls”
3. Delete file “February.xls”

In most file systems, steps 2 and 3 will fail because step 1 will already delete “January.xls” and “February.xls”. There are several ways to address this issue:
1. Silently fail to delete “January.xls” and “February.xls”
2. Delete “January.xls” and “February.xls” before deleting “Reports”.
3. Recognize that deleting “Reports” also deletes “January.xls” and “February.xls” and simply do not perform steps 2 or 3.

The first choice, silently failing to delete the files, could work, but could also produce unintended consequences in other contexts. With data more complex than a file, data corruption could potentially result, along with many other consequences. Additionally, it is poor practice to silently fail; at a minimum, the user should be informed of the issue.

The second choice, deleting the files before deleting the reports, is what delete swapping accomplishes. By reversing the order of the dependencies, items that are deleted are done so “from the bottom up”, and all tasks can then complete successfully. The procedure of delete swapping is handled as described above in order to allow the difference translators to generate delete task dependencies in the same way as other tasks. This minimizes the complexity of the difference translators.

The third choice, optimizing away the tasks to delete the files, is a step best left to the individual difference translators. In some cases (such as with the file example presented), this may be a valid optimization step, but in other cases, it may be unnecessary or even impossible. The difference translators should have all the knowledge of how to handle their own types of data, and so they should be able to decide when and if to apply this optimization.

The pseudocode for the generation system is presented below in Table 6. The system takes the following inputs:

States, an array of state files that contain state information

Differences, an array of differences between the state files, consisting of:
Key, the unique key of the item that is different
Difference, the type of difference that is being expressed
FileRef, a reference to the state file that is involved in the difference

PlanGenerators, an array of difference translator extensions

One embodiment of the system's pseudocode:

TABLE 6

```
Procedure GenerateTasks(States, Differences)
  -- first, build a graph of items
  Let V = a new list of Items
  For each Difference in Differences
    Let X = the Item in States[Difference.FileRef]
    Add X to V
  -- now, connect dependencies
  -- the pseudocode for this procedure can be found in A method
  -- of determining dependencies between items in a graph in
  -- an extensible system
  BuildDependencies(V)
  -- ask each plan generator about each key
  -- each plan generator is responsible for generating tasks
  For each Item in V
    For each PlanGenerator in PlanGenerators
      if PlanGenerator can handle Item
        PlanGenerator(ltem, V)
  -- at this point, all tasks have been generated
End Procedure
```

Of particular note in the pseudocode is the final loop in which each difference translator generates tasks. Each specific implementation may have a different approach in performing this step. In one embodiment, the difference translator could be provided with the list of all items that it should generate tasks for. This approach offers an advantage in that the difference translator can see the “entire picture” of tasks at once, and perform optimizations such as those discussed above. Such optimizations may be difficult or impossible if each difference translator is made to look at a single item at a time.

After the list of tasks is generated, the natural inclination is then to execute them with some mechanism. However, a variety of other options are possible, such as using the tasks as documentation for the differences between two states. Alternatively, an end-user could be offered a chance to edit the tasks and customize the generated output.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of depictions and other examples. Insofar as such depictions and examples contain one or more functions and/or operations, it will be understood as notorious by those within the art that each function and/or operation within such depictions and examples can be implemented, individually and/or collectively, by a wide range of hardware, software, firmware, or virtually any combination thereof.

From the foregoing it will be appreciated that, although specific implementations of the invention have been described herein for purposes of illustration, various modifications may be made without deviating from the spirit and scope of the invention. Accordingly, the invention is not limited except as by the appended claims.

The invention claimed is:

1. For a source data storage having a first state and a target data storage having a second state, a method comprising;
receiving a first state file representing the first state of the source data storage;
receiving a second state file representing the second state of the target data storage;
receiving a list of differences between the first state file and the second state file; and
based at least in part on the first state file, the second state file, and the list of differences, generating at least one task extension to perform at least one action on data of one of the following: the first state file and the second state file.

2. The method of claim 1 wherein the generating the at least one task includes declaring a dependency upon another task associated with the at least one task.

3. The method of claim 2 wherein the dependency is swapped if an delete action is associated therewith.

4. The method of claim 1 wherein each of the at least one task extension is generated through in part use of a translation table.

5. The method of claim 4 wherein the translation table includes items involving difference categories including at least one of the following: same, not in source, not in target, different.

6. The method of claim 1 wherein the at least one action includes at least one of the following: creating, modifying, deleting, or accessing at least one of the following: files, folders, database tables, database views, database table columns, database table rows, database metadata, database scripts, security descriptors, computer metadata, objects or data,

7. The method of claim 1 wherein items in the first state file are identified by a first key and items in the second state file are identified by a second key.

8. The method of claim 1 wherein items in the first state file and the second state file contain produced and consumed evidence to construct a dependency graph.

9. The method of claim 8 wherein the first state file and the second state file are formatted to provide an index into a produced evidence store to generate the dependency graph.

10. The method of claim 1 wherein the generating the at least one task includes calling application program interfaces.

11. The method of claim 1 wherein the list of differences includes difference states of all items in the first state file and the second state file.

12. The method of claim 11 wherein the list of differences includes an entry for each of the difference states identifying a state file that is associated therewith.

13. The method of claim 1 wherein the list of differences includes a description of the nature of each difference.

14. The method of claim 1 wherein generating the at least one task extension to perform the at least one action on data includes using a different difference translator for each class of input data.

15. The method of claim 14 wherein the at least one task extension are instances of an object-oriented programming class.

16. The method of claim 1 wherein each of the at least one task is used for a specific type of data.

17. For a source data storage having a first state and a target data storage having a second state, a method comprising:
analyzing state differences between the first state and the second state to generate a difference list having a number of differences between the first state and the second state greater than zero; and
executing task extensions on the target data storage based at least in part upon the difference list to cause actions to occur to reduce the number of differences between the first state and the second state equal to zero.

18. For a source data storage having a first state and a target data storage having a second state, a computer readable media containing instructions for computer execution of a method, the method comprising;
receiving a first state file representing the first state of the source data storage;
receiving a second state file representing the second state of the target data storage;
receiving a list of differences between the first state file and the second state file; and
based at least in part on the first state file, the second state file, and the list of differences, generating at least one task extension to perform at least one action on data of one of the following: the first state file and the second state file.
